(19) United States
(12) Patent Application Publication
(10) Pub. No.: US 2005/0219617 A1
(43) Pub. Date: Oct. 6, 2005

(54) Image processing device, image processing method, and computer program product for image processing

(75) Inventors: Takatoshi Mochizuki, Itami-Shi (JP); Naoko Hiramatsu, Kyoto-Shi (JP)

Correspondence Address: McDermott Will & Emery LLP, 600 13th Street, N. W., Washington, DC, 20005-3096, US

(73) Assignee: MINOLTA CO., LTD., Osaka (JP)

(21) Appl. No.: 11/034,923

(22) Filed: Jan. 14, 2005

Related U.S. Application Data
(63) Continuation of application No. 09/620,473, filed on Jul. 20, 2000, now abandoned.

(30) Foreign Application Priority Data
Jul. 22, 2000 (JP) 11-207564

(51) Int. Cl. G06K 15/02; H04N 1/50

(52) U.S. Cl. 358/1.18; 358/537

(57) ABSTRACT

An image processing device automatically generates a frame image around a periphery of a subject image. A color of the frame image is determined by an image processing device based on a feature of the subject image. The feature is related to colors of the subject image. For example, the feature is a color having the largest surface area within the subject image. A similar color to the feature color is determined as the color of frame.

This application is based on Patent Application No. 11-207564 filed in Japan, the content of which is hereby incorporated by reference.

### BACKGROUND OF THE INVENTION

1. Field of the Invention

The present invention relates to an image processing device, image processing method, and computer program product for image processing for use in processing digital images.

2. Description of the Related Art

Digital images are subjected to various types of image processing such as image correction and image treatment to achieve a special effect. One type of special effect is image synthesis, wherein a single image is synthesized from a plurality of images.

Coincident with the popularization of digital cameras is an increase in the number of people who enjoy processing digital images. In particular, synthesizing a frame and image has even come to be performed with silver halide photography. Producing a frame image is one type of image synthesis. A framed image is a synthesis of a photographic image to a frame image forming the basis of the synthesis.

A photograph produces a moderately altered impression by the addition of a frame. The color of a frame in particular has a large influence. Diverse kinds of ambience can be created by considering the color scheme of the frame color and color tone of an image. However, determining a frame color can be vexatious for a user. It is therefore desirable to aid the user to more easily determine frame color.

### OBJECTS AND SUMMARY

An object of the present invention in view of the previously described information is to provide an image processing device, image processing method, and computer program product suitable for handling digital images.

Another object of the present invention is to provide an image processing device, image processing method, and computer program product for image processing for creating an optimized frame image for combination with a digital image.

Pursuant to a certain aspect of the present invention, these and other objects are attained by an image processing device provided with an extraction controller for extracting image color (e.g., hue, brightness, chroma), a determination controller for determining a frame color based on the feature quantity of the color extracted by the extraction controller, and a synthesis controller for generating a frame of a frame color determined by the determination controller around the image and synthesizing a product image. In this image processing device, a frame color matching the color expression of the image is automatically determined from the percentage of the feature color and its surface area within the image.

For example, the determination controller may set a frame color of the same system as the color of the system having the largest surface area within the image.

For example, the determination controller may set a frame color to an intermediate color between the color of the system having the largest surface area within the image and a color of the system having the next largest area.

For example, the determination controller may set a frame color to a color of the same system as a color determined to be the most conspicuous within an image.

For example, the determination controller may set a frame color to d color of a system equivalent to a complementary color of a color determined to be the most conspicuous within an image.

For example, the determination controller may suggest a plurality of frame color candidates based on the feature quantity of color extracted by the extraction controller, and a user may make a selection from among the plurality of suggested frame color candidates.

Pursuant to a certain aspect of the present invention, these and other objects are attained by an image processing method wherein a feature quantity of a color of an image is extracted, a frame color is determined based on the feature quantity of the extracted color, and a frame of the determined color is generated around the periphery of the image and combined with the image.

Pursuant to a certain aspect of the present invention, these and other objects are attained by a computer program product executed by a computer and comprising an extraction control for extracting the feature quantity of a color of an image, determination control for determining a frame color based on the feature quantity of the extracted color, and generation control for generating a frame of the determined frame color around the periphery of the image.

Pursuant to a certain aspect of the present invention, these and other objects are attained by an image processing device comprising a specification controller for a user to specify a color within an image, a setting controller for setting a frame color from a color specified by the specifying controller, and a synthesis controller for generating a frame of a frame color set by the setting controller around the periphery of an image and combining with the image.

Pursuant to a certain aspect of the present invention, these and other objects are attained by an image processing method, wherein a user specifies a color in an image, a frame color is set based on the specified color, and a frame of the specified color is generated around the periphery of the image and combined therewith.

Pursuant to a certain aspect of the present invention, these and other objects are attained by a computer program product executed by a computer and comprising specification control for a user to specify a color in an image, setting control for setting a frame color from the specified color, and synthesis control for generating a frame of the set frame color around the periphery of the image and combining therewith.

### BRIEF DESCRIPTION OF THE DRAWINGS

These and other objects and features of the present invention will become apparent from the following description of the preferred embodiments thereof taken in conjunction with the accompanying drawings, in which:

FIG. 1 shows the overall structure of the system;

FIG. 2 is a block diagram centered on a control device;

FIG. 3 shows the situation of combining a frame with an image;

FIG. 4 is a flow chart of the main routine of the frame process;

FIG. 5 is a flow chart of frame color determination;

FIG. 6 is a flow chart of the frame synthesis result display process; and

FIG. 7 is a flow chart of the frame color determination of another embodiment.

In the following description, like parts are designated by like reference numbers throughout the several drawings.

### DETAILED DESCRIPTION OF THE PREFERRED EMBODIMENTS

The preferred embodiments of the present invention are described hereinafter with reference to the accompanying drawings. In the drawings, like reference numbers refer to like or equivalent parts.

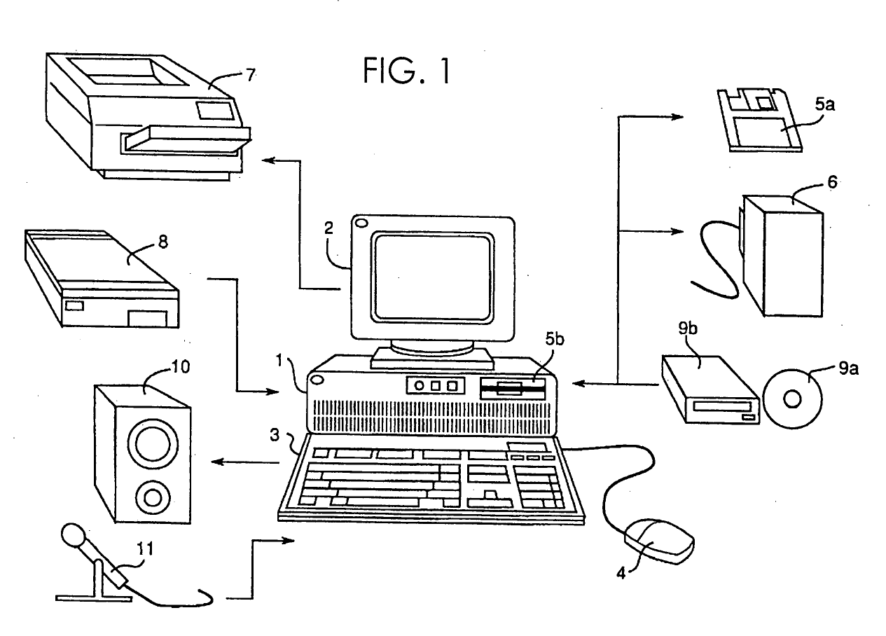

The information processing device of an embodiment of the present invention (hereinafter referred to as the “system”) mainly comprises a control device 1 (computer) for controlling the entire system and provided with a central processing device (hereinafter referred to as “CPU”). In FIG. 1, the arrows represent the data flow direction. A display 2 both displays images and text, and displays various types of screens for operation. A keyboard 3 and a mouse 4 are used for various types of input and instruction operations. A floppy disk 5a and a hard disk 6 are storage media for recording and storing image data and the attendant attribute information, and the system is provided with a floppy disk drive 5b and a hard disk drive to provide access to the floppy disk 5a and the hard disk 6. A printer 7 prints image data and the like on a paper sheet. A scanner 8 reads image data from a document. A CD-ROM 9 is a recording medium for storing large quantities of image data, and the system is provided with a CD-ROM drive 9b for accessing the CD-ROM 9a. A speaker 10 for audio output, and a microphone 11 for audio input are connected. An image processing program described later is read from an external recording medium such as CD-ROM 9a or the like.

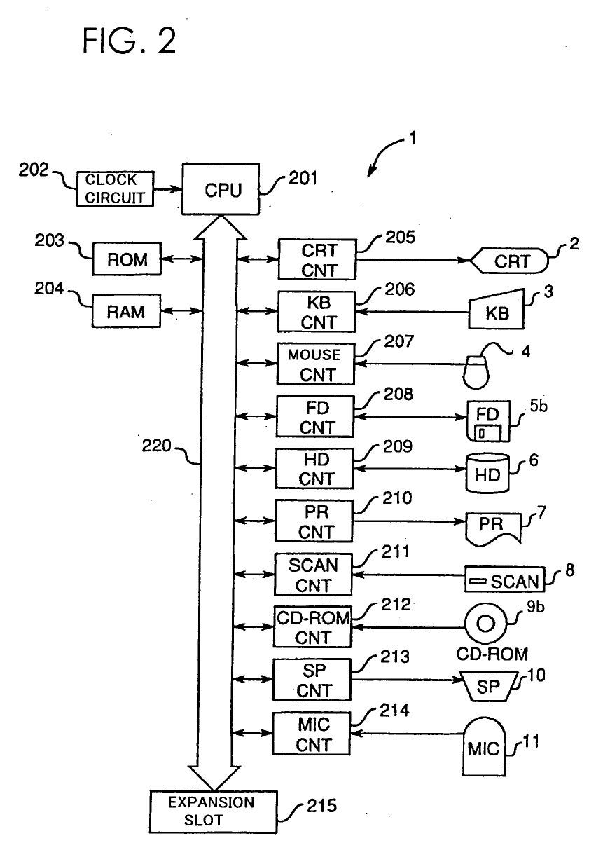

FIG. 2 is a block diagram focused on the control device 1. The control device 1 has a CPU 201 at its center, and the CPU 201 is connected via a data bus 220 to a ROM 203 for storing various processing programs and the like, RAM 204 for storing various data and programs, display control circuit 205 for displaying images or text on the display 2, keyboard control circuit 206 for controlling the transfer of input from the keyboard 3, mouse control circuit 207 for controlling the transfer of input from the mouse 4, floppy disk drive control circuit 208 for controlling the floppy disk drive 5b, hard disk control circuit 209 for controlling the hard disk drive 6, printer control circuit 210 for controlling the output to the printer 7, scanner control circuit 211 for controlling the scanner 8, CD-ROM drive control circuit 212 for controlling the CD-ROM drive 9b, speaker control device 213 for controlling the speaker 10, and microphone control circuit 214 for controlling the microphone 11.

A clock circuit 202 supplies various types of clock signals necessary for system operations. An expansion slot is connected for connecting various types of expansion boards via the data bus. A SCSI board is connected to the expansion slot 215, and a floppy disk drive, hard disk drive, scanner, CD-ROM drive and the like also may be connected.

In this system, the floppy disk 5a and hard disk 6 are used as recording media, but other information storage media such as magneto-optical (MO) media and the like also may be used. Although the scanner 8 and the CD-ROM 9a are used as image data input devices, other input devices such as still/video cameras and the like also may be used. Furthermore, although the printer 7 is used as an output device, other output devices such as a digital copier and the like also may be used.

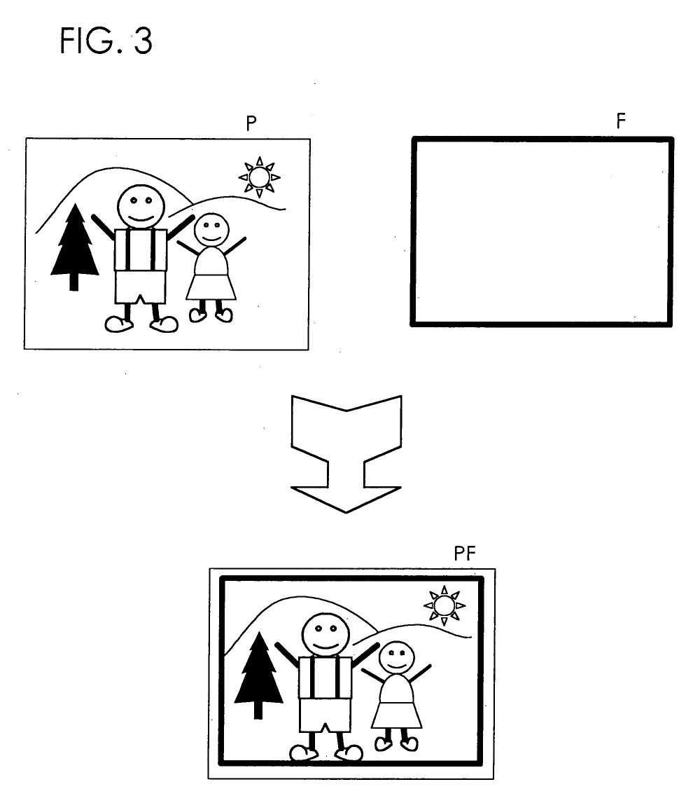

Image data are subjected to various types of image processing (including image treatment) in the image process in this system. As shown in FIG. 3, the frame process of combining a frame F with an image P such as a photograph to obtain a synthesized image PF is one type of image treatment process. In this frame process, a feature color (e.g., hue, brightness, chroma) is extracted from an image, and based on the percentage and surface area of this extracted color within the image, a frame F color matching the color expression of the image is automatically set. In this setting, various methods may be used based on precedents of color schemes in the design field. This is discussed in detail later.

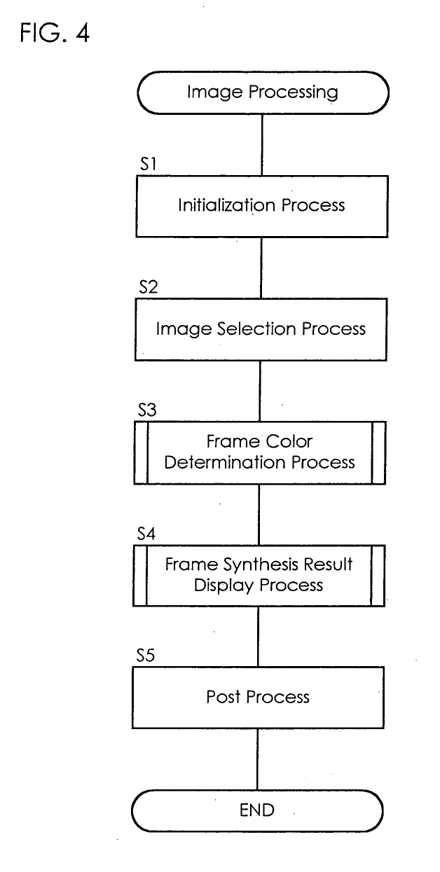

FIG. 4 shows the main routine of the frame process. When the main routine starts, first, an initialization process is executed to set the flags and the like required for the various processes that follow, and to set the initial screen display and the like (step S1). Then, an image P for which a frame is to be generated is selected from among a plurality of images stored on the CD-ROM 9a (step S2). Next, the feature color (e.g., hue, brightness, chroma) of the selected image P is extracted, and the color of frame F to be combined with the image is automatically determined from the percentage and surface area of the feature color in the image (step S3). Next, the frame area is generated in the image P, and filled with the determined frame color, and the synthesized image PF is displayed on the display 2 (step S4). Then, post processing such as saving the image and the like is executed (step S5). The initialization process (step S1), image selection process (step S2), and post process (step S5) are general processes not directly related to the present invention, and, therefore, detailed description of these processes are omitted.

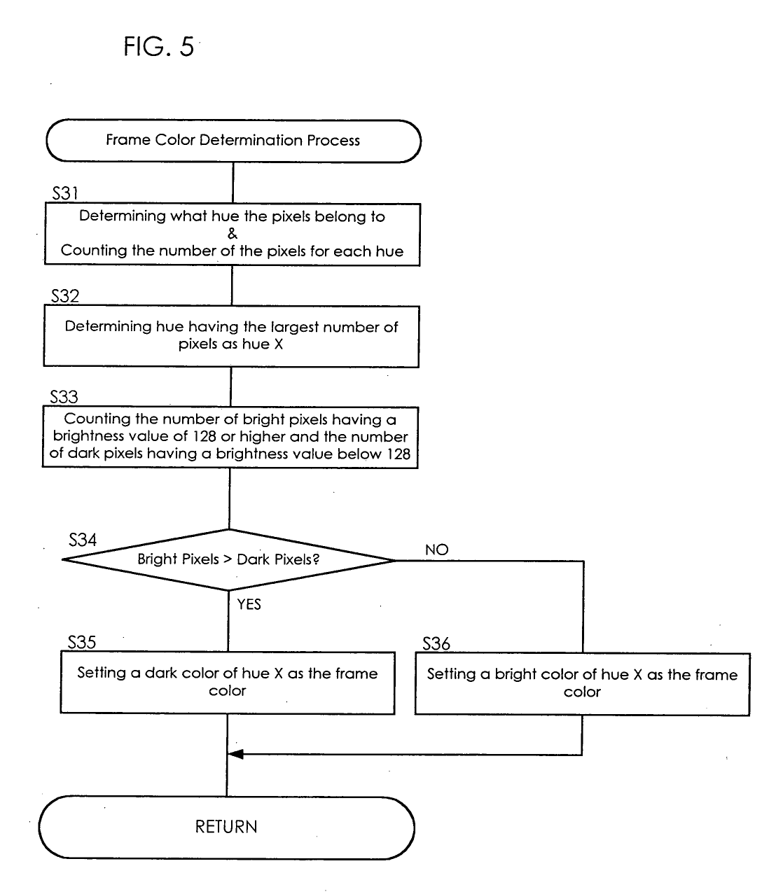

FIG. 5 is a flow chart of the frame color determination (step S3 in FIG. 4). In this process, the frame color is determined from the surface area of each hue in the image. First, each pixel in the image data of the image P selected in step S2 is examined to determine whether or not the color of the pixel is related to the hue of a color wheel or the like, and the number of pixels related to each hue is counted (step S31). Then, hue X related to the largest number of pixels is determined (step S32). Next, brightness information of pixels related to hue X is extracted (step S33). When the brightness information is set at 8 bits (256 gradients), the number of bright pixels having a brightness value of 128 or higher and the number of dark pixels below 128 are counted. Then, a determination is made as to whether or not the majority of the pixels have a brightness value of 128 or higher (step S34). If the bright pixels are in the majority, a dark color of hue X is set as the frame color (step S35). If the bright pixels are not in the majority, a bright color of hue X is set as the frame color (step S36).

Then, the routine returns.

Although the brightness information is set at 256 gradients in step S33, other data also may be used.

In the determination of the frame color, a frame color (same color system) in a tone sequence of modified brightness is selected from the same hue. In steps S34-S36, a dark frame color is set when the majority of pixels are bright, and a bright frame color is set when the majority of pixels are dark, however, the reverse also may be used. Although a frame color different from the determination color is set in steps S34-S36, the same color also may be used.

On the other hand, the frame color may be selected from a different hue. For example, a color of the same color system corresponding to a complement of the color having the largest surface area in the image may be set, or a color of a system of an intermediate color between the color having the largest surface area in the image and the color having the next largest surface area.

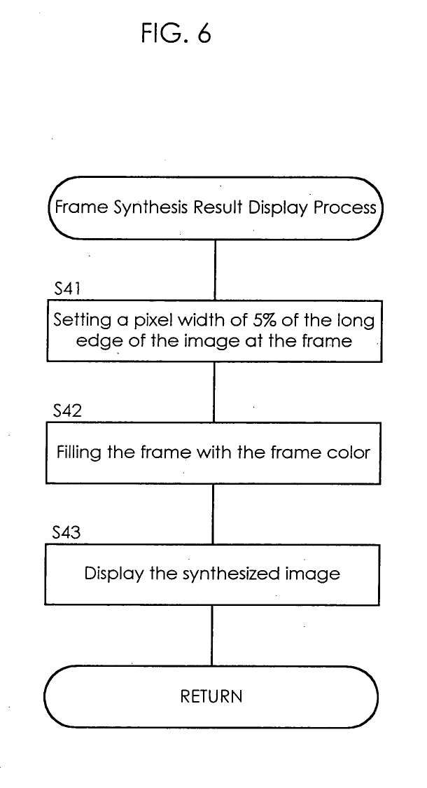

FIG. 6 is a flow chart of the frame synthesis result display process (step S4 in FIG. 4). First, a pixel width of 5% of the long edge of the image P is set as the frame at the image periphery (step S41). Then, the set frame area is filled with the frame color determined in step S3 (step S42). Next, the image with synthesized frame is displayed on the screen (step S43), and the routine returns.

In step S41, 5% of the long edge of the image is the standard frame size. However, a user also may specify. the dimensions of the frame.

In step S43, the image with the synthesized frame is displayed, but after the display a user may be allowed input to determine whether or not the frame color is acceptable.

In another embodiment, the most conspicuous color in an image is determined from the image data in the frame color determination (step S3, FIG. 4). For example, the frame color may be set at a color of the same color system as the determined most conspicuous color, or may be set at a color of a system corresponding to a complement of the most conspicuous color.

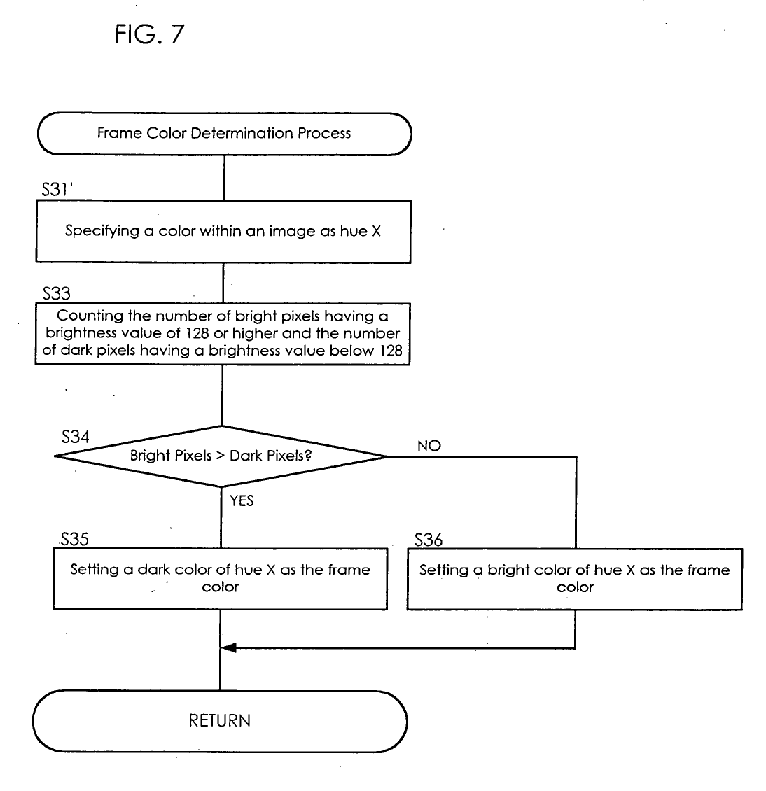

In yet another embodiment, a user specifies a color in an image, and a frame color is set based on the specified color. FIG. 7 is a flow chart of the frame color determination of the embodiment. In this case, steps S31 and S32 of FIG. 5 are replaced by a step (S31′) for a user to specify a color within the image. In this instance, the frame color is set based on the hue included in the color specified by the user. Various types of setting methods similar to those of the aforesaid embodiments may be used in this setting.

In all the embodiments described above only a single color is set as the frame color. However, a plurality of frame color candidates may be determined based on extraction or set color, and presented to a user on the display 2 so as to be selected by a user from among colors displayed. In this case, the frame color determination flow is provided with a step for determining a plurality of frame color candidates, a step for presenting the color candidates to a user via the display 2, and a step for a user to select a frame color.

In the embodiments described above, a frame process program is stored in the ROM 203. However, this program also may be stored on other recording media such as a CD-ROM and the like. Furthermore, the program also may be downloaded from another computer.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

1. An image processing device for processing image data representing an image, said image processing device comprising:
an extraction controller for extracting feature relating to image color of the image from the image data;
a determination controller for determining a frame color based on the feature extracted by said extraction controller; and
a synthesis controller for generating a frame of the frame color determined by the determination controller around the image and synthesizing a product image.

2. An image processing device as claimed in claim 1,
wherein said extraction controller extracts a color system having the largest surface area within the image.

3. An image processing device as claimed in claim 2,
wherein said determination controller sets the frame color to a color belonging to the color system extracted by said extraction controller.

4. An image processing device as claimed in claim 2,
wherein said determination controller sets the frame color to a color belonging to a color system corresponding to a complement of the color system extracted by said extraction controller.

5. An image processing device as claimed in claim 1,
wherein said extraction controller extracts a color system having the largest surface area within the image and a color system having the next largest area within the image.

6. An image processing device as claimed in claim 5,
wherein said determination controller sets the frame color to an intermediate color between the color systems extracted by said extraction controller.

7. An image processing device as claimed in claim 1,
wherein said extraction controller extracts a color which is most conspicuous within the image.

8. An image processing device as claimed in claim 7,
wherein said determination controller sets the frame color to a color belonging to the color system to which the extracted color belongs.

9. An image processing device as claimed in claim 7,
wherein said determination controller sets the frame color to a color belonging to a color system corresponding to a complement of the color extracted by said extraction controller.

10. An image processing device as claimed in claim 1,
wherein said determination controller suggests a plurality of frame color candidates based on the feature extracted by the extraction controller, and determines the frame color according to a selection of a user from among the plurality of suggested frame color candidates.

11. An image processing method for processing image data representing an image, said image processing method comp rising steps of:
extracting a feature quantity of a color of an image;
determining a frame color based on the feature extracted in said extracted step; and
generating a frame of the determined color around a periphery of the image and combining the generated frame with the image.

12. An image processing method as claimed in claim 11,
wherein said extracting step extracts a color system having the largest surface area within the image.

13. An image processing method as claimed in claim 12,
wherein said determining step sets the frame color to a color belonging to the color system extracted by said extracting step.

14. An image processing method as claimed in claim 12,
wherein said determining step sets the frame color to a color belonging to a color system corresponding to a complement of the color system extracted by said extracting step.

15. An image processing method as claimed in claim 14,
wherein said extracting step extracts a color system having the largest surface area within the image and a color system having the next largest area within the image.

16. An image processing method as claimed in claim 15,
wherein said determining step sets the frame color to an intermediate color between the color systems extracted by said extracting step.

17. An image processing method as claimed in claim 11,
wherein said extracting step extracts a color which is most conspicuous within the image.

18. An image processing method as claimed in claim 17,
wherein said determining step sets the frame color to a color belonging to the color system to which the extracted color belongs.

19. An image processing method as claimed in claim 17,
wherein said determining step sets the frame color to a color belonging to a color system corresponding to a complement of the color extracted by said extracting step.

20. An image processing method as claimed in claim 11,
wherein said determining step includes a step of suggesting a plurality of frame color candidates based on the feature extracted by the extracting step, and a step of determining the frame color according to a selection of a user from among the plurality of suggested frame color candidates.

21. A computer program product for processing image data representing an image, said computer program product executing steps of:
extracting a feature quantity of a color of an image;
determining a frame color based on the feature extracted in said extracted step; and
generating a frame of the determined color around a periphery of the image and combining the generated frame with the image.
